(19) United States
(12) Patent Application Publication
(10) Pub. No.: US 2023/0309473 A1
(43) Pub. Date: Oct. 5, 2023

(54) HORTICULTURE DEVICES, SYSTEMS, AND METHODS

(71) Applicant: Coty Perkins, Ogden, UT (US)

(72) Inventor: Coty Perkins, Ogden, UT (US)

(21) Appl. No.: 17/709,288

(22) Filed: Mar. 30, 2022

(51) Int. Cl. A01G 27/00

(52) U.S. Cl. CPC A01G 27/005; A01G 27/003; A01G 27/008

(57) ABSTRACT

Horticulture devices, systems, and methods for growing vegetation are disclosed and described. The horticulture device can include a fluid reservoir operable to receive fluid therein to form a fluid column inside the fluid reservoir. The horticulture device can further include a fluid inlet formed in the fluid reservoir to allow fluid to be introduced into the fluid reservoir. The horticulture device can further include at least one vegetation receptacle in fluid communication with said fluid reservoir. The horticulture device can further include a drain positioned within the fluid reservoir having an opening corresponding to a maximum fluid level for the fluid reservoir.

### BACKGROUND

Gardening and other horticultural pursuits are ubiquitous throughout society. Cultivating plants in gardens serves a wide variety of purposes including producing food, seasonings, herbs, and spices as well as cultivating important ingredients used in pharmaceuticals for treatment and prevention of disease. Plants are also grown for artistic and aesthetic purposes, as well as for human enjoyment and as hobbies.

The amount of available water in a given geographic location often acts as a limiting factor on the amount and type of horticulture that can be used. In some cases, with abundant water, growing activities are nearly unlimited. In other areas, irrigation, or even climate control (e.g. indoor facilities) are required in order to achieve sustainable vegetation output. However, for a variety of reasons, including availability, cost, and current developments with climate change, carefully controlling or otherwise minimizing the use of water while maximizing plant production is highly desirable.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates an isometric view of a horticulture device in accordance with at least one example of the present disclosure.

FIGS. 2A-2D respectively illustrate a top view, a bottom view, a front view, and a side view of the horticulture device of FIG. 1.

FIG. 3 illustrates an exploded isometric view of a horticulture device in accordance with at least one example of the present disclosure.

FIG. 4A illustrates a front view of the horticulture device of FIG. 3.

FIG. 4B illustrates a cross-sectional view of the horticulture device of FIG. 4A taken along line AA.

FIGS. 5A, 5B, 5C, 5D, 5E, and 5F respectively illustrate side, front, cross-section, top, upper isometric, and lower isometric views of a base of the horticulture device of FIG. 3.

FIGS. 6A, 6B, 6C, 6D, 6E, and 6F respectively illustrate top, front, cross-section, side, back, and isometric views of an outer arm of the horticulture device of FIG. 3.

FIGS. 7A, 7B, 7C, and 7D respectively illustrate front, cross-section, upper isometric, and lower isometric views of a vegetation receptacle of the horticulture device of FIG. 3.

FIGS. 8A, 8B, 8C, and 8D respectively illustrate front, cross-section, upper isometric, and lower isometric views of a drain of the horticulture device of FIG. 3.

FIGS. 9A, 9B, 9C, and 9D respectively illustrate front, cross-section, upper isometric, and lower isometric views of an outer chamber of the horticulture device of FIG. 3.

FIGS. 10A, 10B, 10C, and 10D respectively illustrate a front view, a cross-sectional view, an upper isometric view, and a lower isometric view of the inner housing 162 of the horticulture device of FIG. 3.

FIGS. 11A, 11B, 11C, and 11D respectively illustrate a front view, a cross-sectional view, an upper isometric view, and a lower isometric view of the tube 129 of the horticulture device of FIG. 3.

FIGS. 12A, 12B, 12C, and 12D respectively illustrate a front view, a cross-sectional view, an upper isometric view, and a lower isometric view of the cap 122 of the horticulture device of FIG. 3.

FIG. 13 illustrates cross-sectional view of a horticulture device in accordance with at least one example of the present disclosure.

FIG. 14 illustrates cross-sectional view of a horticulture device in accordance with at least one example of the present disclosure.

FIG. 15 illustrates cross-sectional view of a horticulture device in accordance with at least one example of the present disclosure.

FIG. 16 illustrates cross-sectional view of a horticulture device in accordance with at least one example of the present disclosure.

FIG. 17 illustrates cross-sectional view of a horticulture system in accordance with at least one example of the present disclosure.

FIG. 18 illustrates cross-sectional view of horticulture systems in accordance with at least one example of the present disclosure.

FIG. 19 illustrates cross-sectional view of a horticulture system in accordance with at least one example of the present disclosure.

FIGS. 20A, 20B, 20C, and 20D respectively illustrate side, front, cross-section, and isometric views of an outer chamber of the horticulture system of FIG. 3.

FIG. 21 illustrates a horticulture device according to at least one example of the present disclosure.

FIG. 22 illustrates a horticulture growing method according to at least one example of the present disclosure.

FIG. 23 illustrates a horticulture growing method according to at least one example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of compositions, dosage forms, treatments, etc., to provide a thorough understanding of various invention embodiments. One skilled in the relevant art will recognize, however, that such detailed embodiments do not limit the overall inventive concepts articulated herein, but are merely representative thereof.

### Definitions

It should be noted that as used herein, the singular forms “a,” “an,” and, “the” include plural referents unless the context clearly dictates otherwise. Thus, for example, reference to “an excipient” includes reference to one or more of such excipients, and reference to “the carrier” includes reference to one or more of such carriers.

As used herein, the terms “formulation” and “composition” are used interchangeably and refer to a mixture of two or more compounds, elements, or molecules. In some aspects, the terms “formulation” and “composition” may be used to refer to a mixture of one or more active agents with a carrier or other excipients.

As used herein, the term “horticulture” refers to growth and cultivation of plants. “Horticulture” includes olericulture (e.g. the production of vegetables), fruticulture (e.g. the production of fruits and nuts), viticulture (e.g. the production of grapes, and floriculture (e.g. the production of flowering and ornamental plants). Horticultural activities (e.g. growing plants) can be carried out by a variety of techniques and systems, such as hydroponically (e.g. without soil or a substantial growth medium, using soil (e.g. geoponic) or with a non-soil growth medium or substrate including both natural and synthetic materials. It is to be understood that as used in this written description, the term “horticulture” provides express support for all types of plant growth techniques, operations, and activities, including geoponic, hydroponic, or other growth materials and/or mechanism for growing plants. Likewise, as used in this written description, terms referencing specific growth materials, techniques, and/or methods, such as hydroponic and geoponic provide express support for the term “horticulture”.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in the written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” “maximized,” “minimized,” and the like refer to a property of a device, component, composition, or activity that is measurably different from other devices, components, compositions or activities that are in a surrounding or adjacent area, that are similarly situated, that are in a single device or composition or in multiple comparable devices or compositions, that are in a group or class, that are in multiple groups or classes, or as compared to the known state of the art.

The term “coupled,” as used herein, is defined as directly or indirectly connected in a chemical, mechanical, electrical or nonelectrical manner. Objects described herein as being “adjacent to” each other may be in physical contact with each other, in close proximity to each other, or in the same general region or area as each other, as appropriate for the context in which the phrase is used. “Directly coupled” objects, structures, elements, or features are in contact with one another and may be attached. Further as used in this written description, it is to be understand that when using the term “coupled” support is also afforded for “directly coupled” and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, levels and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges or decimal units encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

Disclosed herein is a horticulture device. The horticulture device can include a fluid reservoir operable to receive fluid therein to form a fluid column inside the fluid reservoir. The horticulture device can further include a fluid inlet formed in the fluid reservoir to allow fluid to be introduced into the fluid reservoir. The horticulture device can further include at least one vegetation receptacle in fluid communication with said fluid reservoir. The horticulture device can further include a drain positioned within the fluid reservoir having an opening corresponding to a maximum fluid level for the fluid reservoir.

Further disclosed herein is a method for moving fluid through a horticulture system. The method can include providing fluid through a fluid inlet to a fluid reservoir to form a fluid column in a housing that is fluidly coupled with at least one vegetation receptacle. The method can further include filling the fluid reservoir with fluid to a maximum fluid level indicated by a drain opening positioned within the fluid reservoir. The fluid drain can be operable to induce siphoning of fluid from the fluid reservoir upon introduction of the fluid into the fluid reservoir. The method can further include draining the fluid reservoir through siphoning when the maximum fluid level for the fluid reservoir has been achieved such that fluid enters the drain.

Further disclosed herein is a horticulture system including a plurality of horticulture devices. The horticulture system can include a first horticulture device. The first horticulture device can include a fluid reservoir operable to receive fluid therein to form a fluid column inside the fluid reservoir. The first horticulture device can further include a fluid inlet coupled to the fluid reservoir. The first horticulture device can further include at least one vegetation receptacle in fluid communication with said fluid reservoir. The first horticulture device can further include a drain positioned within the fluid reservoir having an opening corresponding to a maximum fluid level for the fluid reservoir. The horticulture system can further include a second horticulture device. The second horticulture device can include a fluid reservoir operable to receive fluid therein to form a fluid column inside the fluid reservoir. The second horticulture device can further include a fluid inlet coupled to the fluid reservoir. The first horticulture device can further include at least one vegetation receptacle in fluid communication with said fluid reservoir. The second horticulture device can further include a drain positioned within the fluid reservoir having an opening corresponding to a maximum fluid level for the fluid reservoir. The fluid reservoir of the first horticulture device can be in fluid communication with the fluid reservoir of the second horticulture device.

Further disclosed herein is a horticulture method for setting a fluid height in a horticulture device. The method can comprise providing a hydroponic growing device comprising a fluid reservoir, a vegetation receptacle configured to support a plant at a set height, and a drain having an opening positioned at a height relative to the set height. The method can further comprise determining a desired submersion level for a plant to be grown in the hydroponic growing device relative to the set height. The method can further include adjusting the height of the drain to the desired submersion level.

To further describe the present technology, examples are now provided with reference to the figures. Illustrated in the figures are examples of horticulture devices, systems, and methods that utilize reduction and recycling of a horticulture fluid used to hydrate and/or nourish vegetation in horticulture growing systems in order to improve efficiency and decrease waste in horticulture growing systems. The systems and devices further utilize space in a manner that allows for multiples plants to grow in a relatively small space.

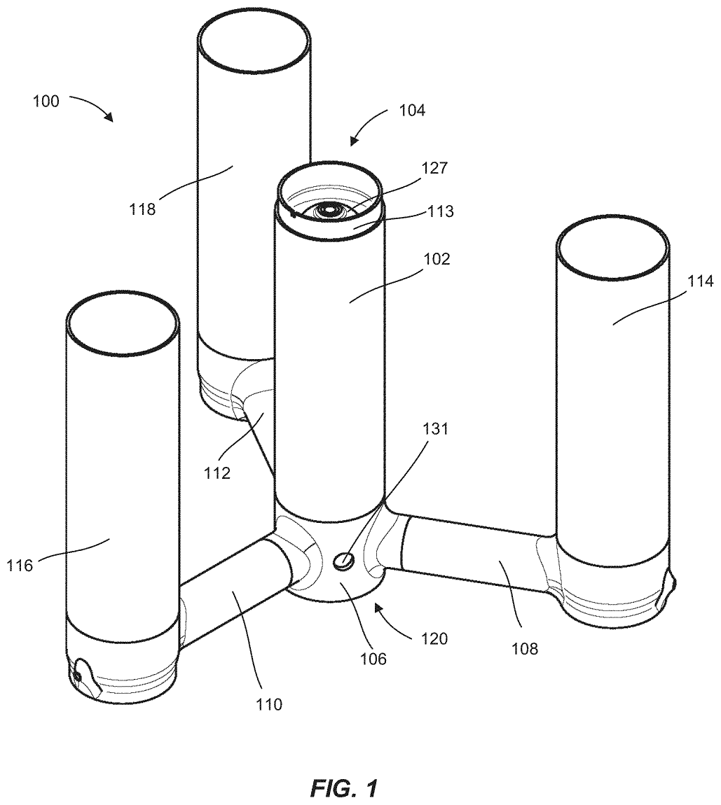

With reference to FIG. 1, illustrated is a horticulture device 100 in accordance with an example of the present disclosure. The horticulture device 100 is operable to receive a plurality of plants/vegetation in one or more vegetation receptacles. Each vegetation receptacle can be in fluid communication with a central fluid reservoir that receives a fluid for delivering nutrients to vegetation. The fluid used to provide nutrients and hydration to vegetation is not intended to be limited by this disclosure in any way. The fluid can include water with nutrients dissolved and suspended therein, or any other aqueous solution used to provide nutrients and hydration growing vegetation. Similarly the composition of nutrients within the fluid are not intended to be limited by this disclosure in any way. For convenience, this disclosure will simply refer to the fluid and nutrients used to hydrate and nourish growing plants as “fluid.”

As shown in FIG. 1, the horticulture device 100 can include a fluid reservoir 102 located centrally in the horticulture device 100. The fluid reservoir 102 can include an inlet 104 formed as an opening in the fluid reservoir 102 for receiving liquids and/or gasses into the fluid reservoir 102. The fluid reservoir 102 can be configured to receive fluid therein to form a fluid column inside the fluid reservoir 102 and to supply the fluid to vegetation in the horticulture device 100. The fluid reservoir 102 can be coupled to a base 106 such that the fluid reservoir 102 is in fluid communication with the base 106. The fluid reservoir 102 can extend vertically from the base to form a housing for housing the fluid column therein. One or more outer arms 108, 110, and 112 can extend from the base 106 to allow fluid to flow from the fluid reservoir 102 to the base 106 and through arms 108, 110, and 112. The arms 108, 110, and 112 are operable to convey the fluid to and from respective vegetation receptacles 114, 116, and 118 in fluid communication with the arms 108, 110, and 112 and in fluid communication with the fluid reservoir 102 via the arms 108, 110, and 112. The vegetation receptacles 114, 116, and 118 are configured to receive and support one or more plants or pieces of vegetation that can be grown therein. The horticulture device 100 can further include a fluid outlet 120 formed as an opening in the bottom of the fluid reservoir 102 configured to allow fluid to exit the horticulture device 100.

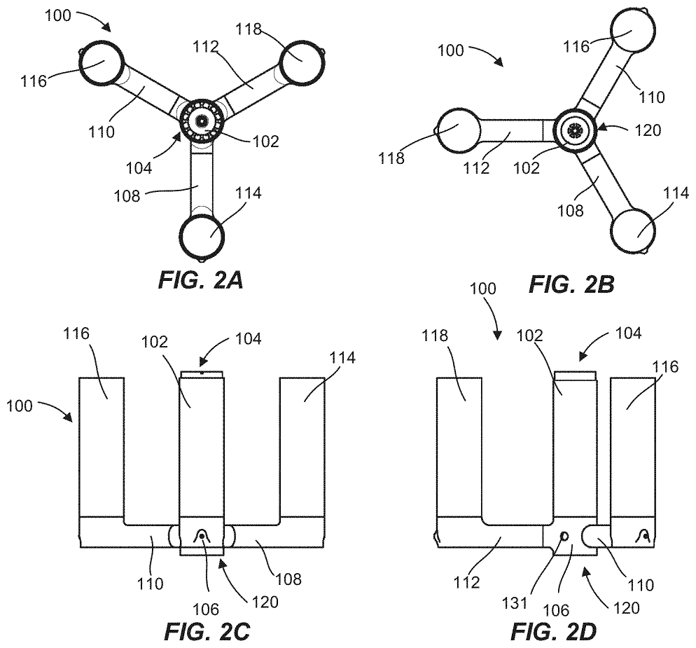

To provide further detail, additional views of the horticulture device 100 are illustrated in FIGS. 2A, 2B, 2C, and 2D. FIG. 2A illustrates a top view of the horticulture device 100 and FIG. 2B illustrates a bottom view of the horticulture device 100. As illustrated in FIGS. 2A and 2B, the horticulture device 100 can include three arms 108, 110, and 112 extending outward from the fluid reservoir 102 and the base 106 to support vegetation receptacles 114, 116, and 118. As shown, the arms 108, 110, and 112 can be spaced at equal angles from each other around the fluid reservoir 102 and the base 106. The number of vegetation receptacles that can be spaced around the fluid reservoir 102 and the base 106 is not intended to be limited in any way by this disclosure. Any number of arms/vegetation receptacles (e.g., one, two, three, four, five, six, or more.) can be spaced around the fluid reservoir 102 and the base 106. Additionally, the spacing between arms and vegetation receptacles around the fluid reservoir 102 and the base 106 is not intended to be limited in any way. All of the arms and vegetation receptacles can be spaced at equal angles around the base 106, one or more of the arms and/or vegetation receptacles can be spaced at a different angle(s) than other arms and vegetation receptacles, or all of the arms and vegetation receptacles can be spaced at different angles around the base 106 and the fluid reservoir 102 with respect to each other.

Spacing the vegetation receptacles 114, 116, and 118 and the arms 108, 110, and 112 around the fluid reservoir 102 as shown in the figures allows for the fluid weight distribution within the horticulture device 100 to be centered over and evenly distributed about and around the fluid reservoir 102. Therefore, the arrangement of the arms and vegetation receptacles around the fluid reservoir 102 can increase stability of the horticulture device 100. It will be appreciated by those of ordinary skill in the art that the configuration shown is not the only configuration that will provide stability to a horticulture device. Many configurations, angles between arms and receptacles, and spacing of the arms and receptacles around the fluid reservoir 102 can be used to provide stability to the horticulture device 100, particularly if the center of gravity of the fluid distribution in the horticulture device 100 substantially coincides with the center of gravity of the horticulture device 100.

FIGS. 2C and 2D illustrate front and side views of the horticulture device 100. As shown each of the arms 108, 110, and 112 extend away from the base 106 at a same height as the other arms. However, the vertical positions of the arms extending away from the base 106 and the fluid reservoir 102 are not intended to be limited by this disclosure in any way. For example, one or more arms out of the arms 108, 110, and 112 can extend away from a center of the horticulture device 100 at a higher height with respect to the base 106 and the fluid reservoir 102 than the remaining arms. Additionally, all of the arms can extend away from the base 106 or reservoir 102 at different heights from each other.

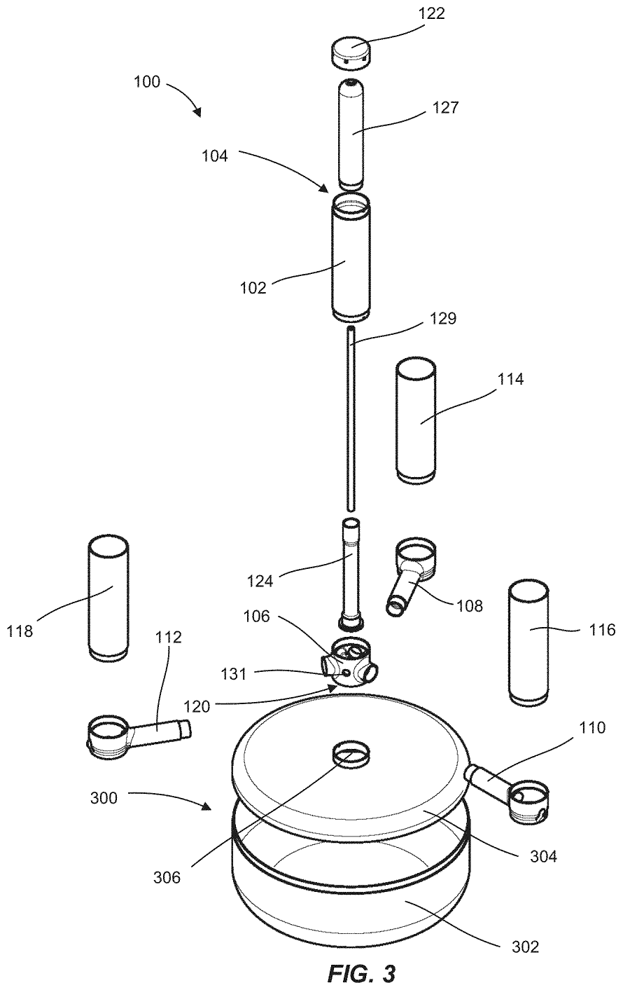

FIG. 3 illustrates an exploded view of horticulture device 100 and a bottom fluid reservoir 300 in fluid communication with the fluid outlet 120 of the horticulture device 100. As shown in the exploded view of FIG. 3, each of the arms 108, 110, and 112 can interface and be attached to the base 106. Each of the vegetation receptacles 114, 116, and 118 can interface and be attached to each of the arms 108, 110, and 112. The fluid reservoir 102 can also interface and be attached to the base 106. Additionally, the horticulture device 100 can further include a cap 122 that interfaces with and covers the inlet 104 of the fluid reservoir 102. The cap 122 can cover and protect the inlet 104 and internal portion of the fluid reservoir 102. Additionally, the cap 122 can include one or more inlets 131 formed therein to allow fluid to be introduced into the fluid reservoir 102 through the cap 122 or to act as an air pressure releases or vents to allow for equalization of air pressure in the fluid reservoir 102 as the fluid reservoir 102 drains.

The horticulture device 100 can further include a drain 124 that interfaces and attaches to the base 106 and that is housed inside of the fluid reservoir 102. The drain 124 can be housed inside of an inner housing 127 disposed within the fluid reservoir 102. The drain 124 can attach and interface with the base 106 at the fluid outlet 120 of the base 106 such that fluid exiting the horticulture device 100 exits through the drain 124. One or more inlets 133 can be formed in the base 106. The inlets 133 can allow for venting and equalization of air pressure within the fluid reservoir 102 as fluid moves throughout the fluid reservoir 102.

The horticulture device 100 can interface with the bottom fluid reservoir 300 by the base 106. The bottom fluid reservoir 300 can comprise a basin 302 for collecting fluid passing through the horticulture device 100 and exiting through the fluid outlet 120. The bottom fluid reservoir 300 can further include a lid 304 that covers the basin 302. The lid 304 can have an inlet 306 formed therein that is configured to interface with the fluid outlet 120 of the base 106 of the horticulture device 100. It is to be understood that the bottom fluid reservoir need not be a structured basin. The horticulture device 100 can be placed in a lake, lagoon, pond, or other body of water to act as the bottom fluid reservoir. A pump P may be used in conjunction with the bottom fluid reservoir 300 or with a body of water to pump fluid from the bottom of the horticulture device 100 to the inlet 104 at a top of the horticulture device 100. Additionally or alternatively, a tube 129 can be in fluid communication with the pump P and the bottom fluid reservoir 300 to convey fluid from the bottom fluid reservoir 300 to the top of the fluid reservoir 102. The tube 129 can be housed inside of the drain 124 and the fluid reservoir 102 to convey fluid to a top of the fluid reservoir 102 through a middle of the fluid reservoir 102. The flow path in various examples described herein will be discussed elsewhere in this application.

Each of the parts of the horticulture device 100 and the bottom fluid reservoir 300 that interface and attach together can attach via threaded connections, press fitting, interference fitting, adhesive, welding, or any other known method of attaching parts together. The method of attaching parts together is not intended to be limited in any way by this disclosure. Additionally, the horticulture device 100 can be entirely 3D printed by additive manufacturing to form a single monolithic structure. Additionally, the horticulture device can be manufactured separately in discrete parts by any known manufacturing method, or can be manufactured monolithically as one piece by any known methods such as subtractive manufacturing, injection molding, casting or any other known method of manufacturing without limitation.

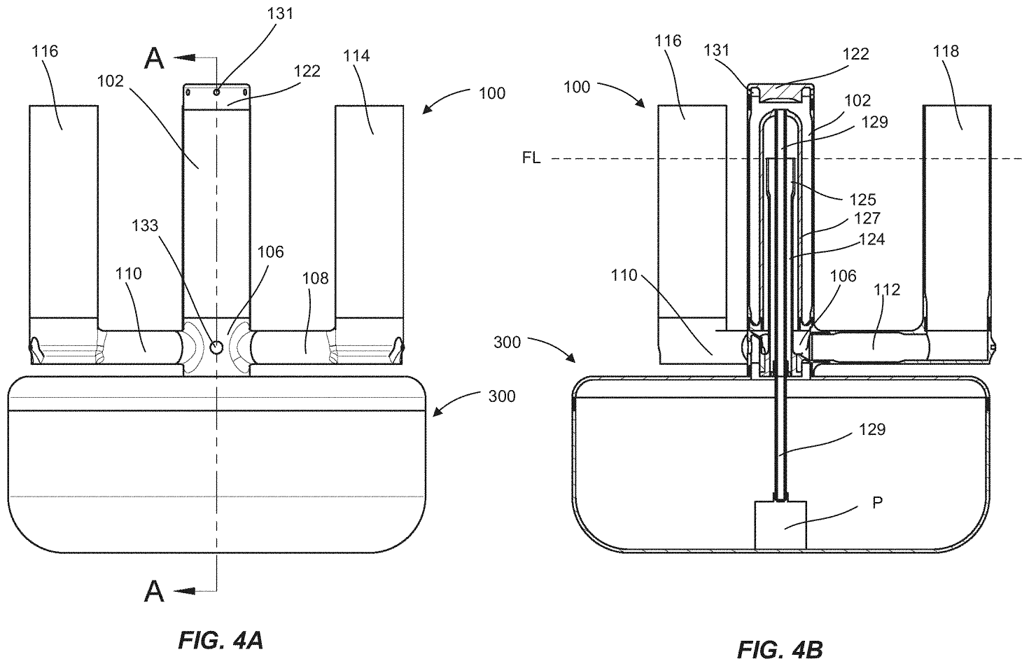

FIG. 4A illustrates an assembly view of the horticulture device 100 connected to the bottom fluid reservoir 300. FIG. 4B illustrates a cross sectional view of horticulture device 100 and bottom fluid reservoir 300 taken along line AA in FIG. 4A. As illustrated in FIG. 4B the drain 124 can be housed within fluid reservoir 102 and can further include a funnel 125 configured to be an inlet of the drain 124. The funnel 125 can have a wider opening then the rest of the drain 124 and can therefore allow more fluid into the drain. The increase of fluid through the drain can lead to an increase in siphoning compared to a situation where the funnel 125 is not included in the drain 124. The fluid flow between the horticulture device 100, the drain 124, and the bottom fluid reservoir 300 will be described in more detail later with reference to other figures. The opening at the funnel 125 of the drain can correspond to a maximum fluid level FL for the fluid reservoir 102 and the vegetation receptacles 114, 116, and 118.

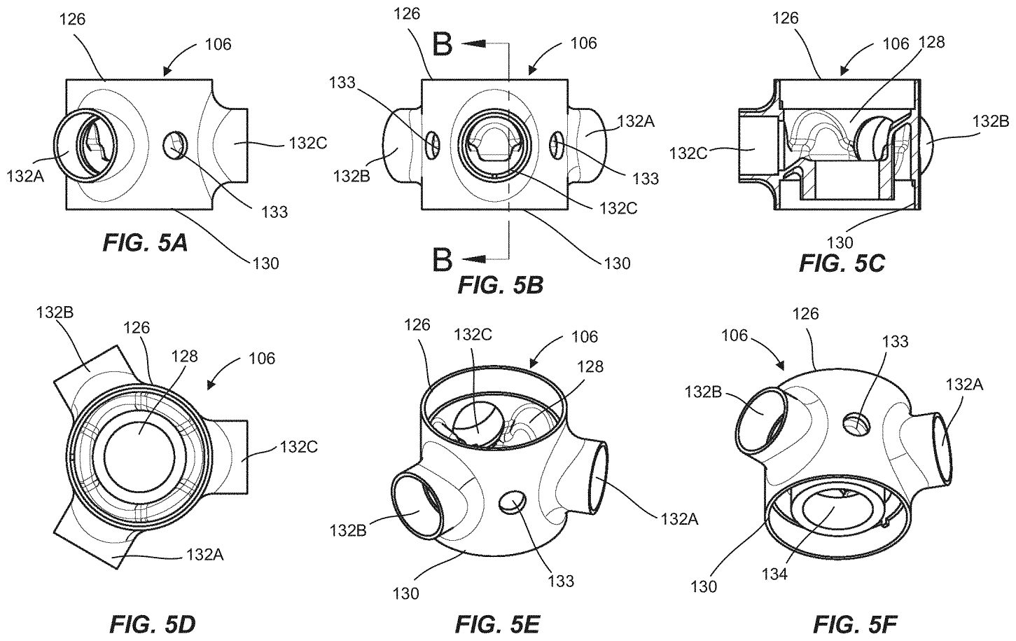

Each portion of horticulture device 100 is described with reference to FIGS. 5A through 9D. FIGS. 5A, 5B, 5C, 5D, 5E, and 5F respectively illustrate side, front, cross-sectional, top, upper isometric, and lower isometric views of the base 106 of the horticulture device 100. As illustrated in FIGS. 5A-5F, the base 106 can include a housing 126 that defines an inner cavity 128. The inner cavity 128 is shown in the cross sectional view of the base 106 shown in FIG. 5C, which is a cross section taken along line BB in FIG. 5B. An upper portion of the housing 126 can be configured to attach to or interface with the fluid reservoir 102 to provide fluid communication between the fluid reservoir 102 and the base 106. The base 106 can further include a lower interface 130 at the lower portion of the housing 126 that is configured to attach to the inlet 306 of the bottom fluid reservoir 300 to provide fluid communication between the base 106 and the bottom fluid reservoir 300. The base 106 can further comprise branches 132A, 132B, and 132C extending from the housing 106 and configured to attach to one or more arms leading to the vegetation receptacles. The branches 132A, 132B, and 132C can provide fluid communication between the base 106 and the arms 108, 110, and 112 of the horticulture device 100. Additionally, the base 106 can include a drain interface 134 configured to attach to the drain 124 and to provide fluid communication between the base 106 and the drain 124. The lower interface 130 can further provide fluid communication between the drain 124 and the bottom fluid reservoir 300. One or more inlets 133 can be formed in the base 106 to allow for venting and equalization of air pressure within the fluid reservoir 102 as fluid moves throughout the fluid reservoir 102.

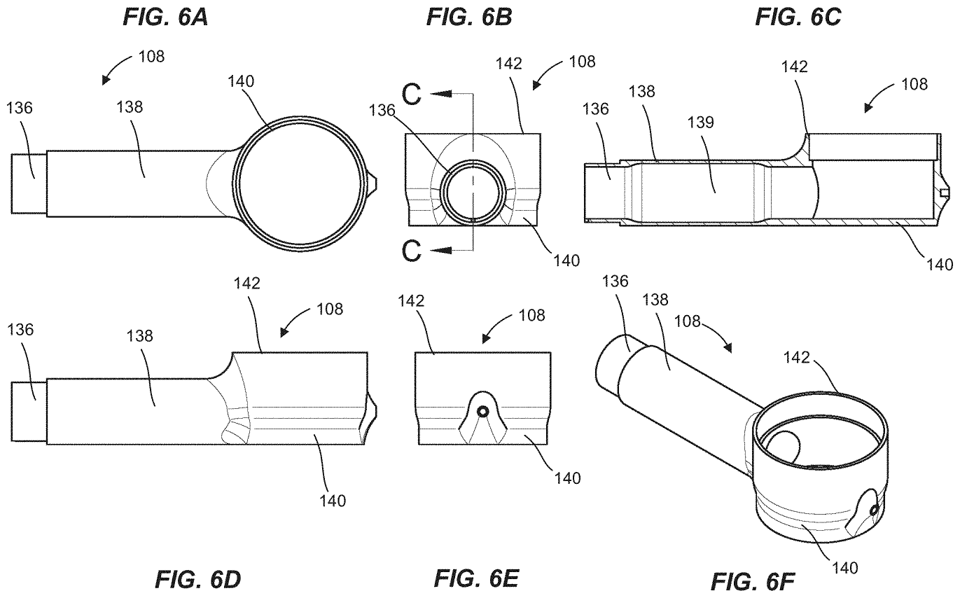

FIGS. 6A, 6B, 6C, 6D, 6E, and 6F respectively illustrate a top view, a front view, a cross-sectional view (taken along line CC of FIG. 6B), a side view, a back view, and an isometric view of an outer arm 108 of the horticulture device 100. While the figures illustrate the arm 108 specifically, it is to be understood that the arms 110 and 112 and any additional arms can have the same or similar configurations to the arm 108. As illustrated in FIGS. 6A-6F, the arm 108 can include an interface 136 configured to attach to one of the branches 132A, 132B, or 132C of the base 106 to provide fluid communication between the base 106 and the arm 108. The arm 108 can further include a midsection 138 and an end section 140 that together define an inner cavity 139 through which fluid can flow through the arm 108. The arm 108 can further include a receptacle interface 142 at the end section 140 that is configured to facilitate attachment between the arm 108 and a vegetation receptacle 114. Therefore, the arm 108 facilitates fluid communication between the base 106 and the vegetation receptacle 114 attached to the arm 108.

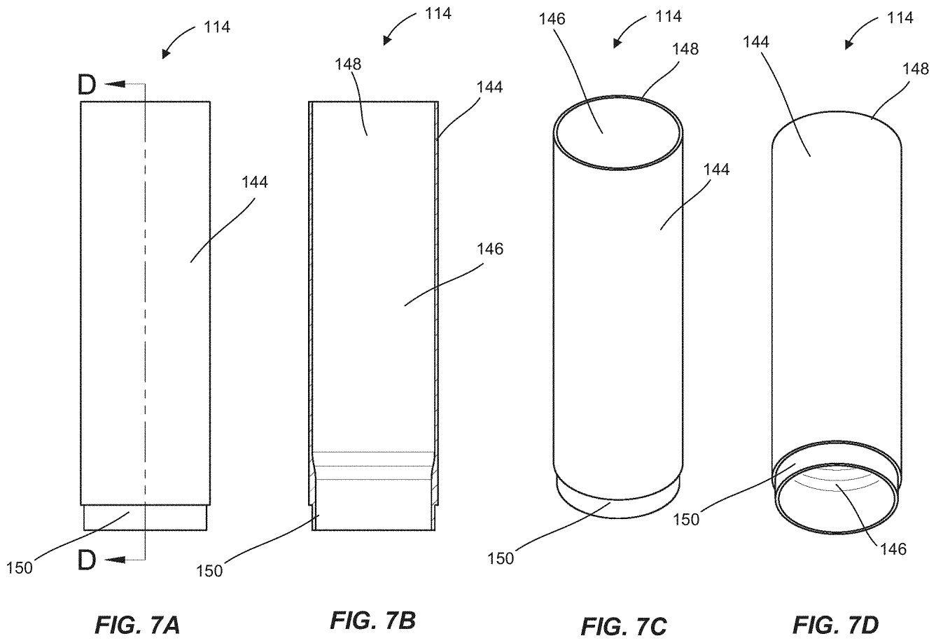

FIGS. 7A, 7B, 7C, and 7D respectively illustrate a front view, a cross-sectional view (taken along line DD of FIG. 7A), an upper isometric view, and a lower isometric view of a vegetation receptacle 114 of the horticulture device 100. While the figures illustrate the vegetation receptacle 114 specifically, it is to be understood that the vegetation receptacles 116 and 118 can have the same or similar configurations to the vegetation receptacle 114. As shown, the vegetation receptacle 114 can comprise a housing 144 that defines an inner cavity 146 that provides fluid communication in the vegetation receptacle 114 and can support a plant to be grown in the vegetation receptacle 114. An opening 148 can be formed in the top of the housing 144 that can be configured to receive a plant and to allow for growth of the plant out of the vegetation receptacle 114. The vegetation receptacle 114 can additionally comprise an arm interface 150 configured to interface with and attach to the arm 108 by receptacle interface 142 to provide fluid communication between the arm 108 and the vegetation receptacle 114.

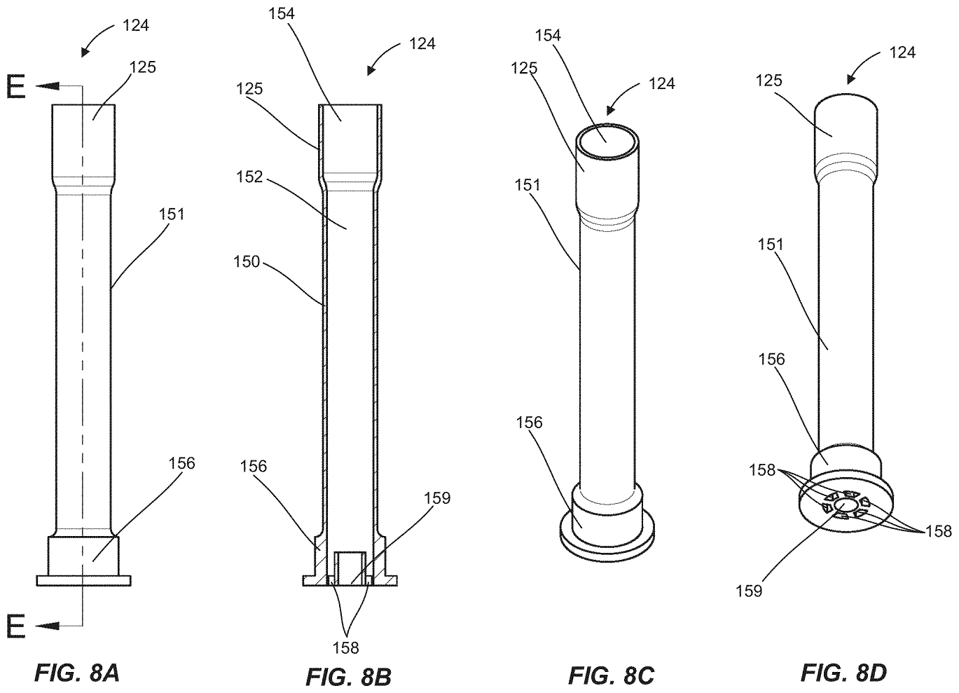

FIGS. 8A, 8B, 8C, and 8D respectively illustrate a front view, a cross-sectional view (taken along line EE of FIG. 8A), an upper isometric view, and a lower isometric view of the drain 124 of the horticulture device 100. As shown, the drain 124 can include a funnel 125 at an upper portion thereof. The drain 124 can further include a housing 150. Together the funnel 125 and the housing 150 can define an inner cavity 152 and an opening 154 of the drain 124. The opening 154 can receive fluid therein and cause fluid to flow within the drain 124. The drain 124 can include a base interface 156 configured to attach the drain 124 to the interface 134 of the base 106. The drain 124 can further include a plurality of holes 158 formed in a bottom end of the drain 124 to facilitate draining fluid from the drain 124 and to provide fluid communication between the drain 124 and the fluid outlet 120 of the horticulture device 100. The drain 124 can further include a tube interface 159 that is a hole formed in the bottom of the drain 124 configured to receive the tube 129 there through, allowing the tube 129 to extend upward through the inner cavity 152 of the drain 124 to provide a fluid passage from the bottom fluid reservoir 300 to the fluid reservoir 102. When installed within the fluid reservoir 102, the drain 124 provides fluid communication between the fluid reservoir 102 and the bottom fluid reservoir 300. The drain 124 further provides fluid communication between the horticulture device 100 as a whole to allow fluid to exit the horticulture device 100 and enter another system, element, object, device, and/or environment.

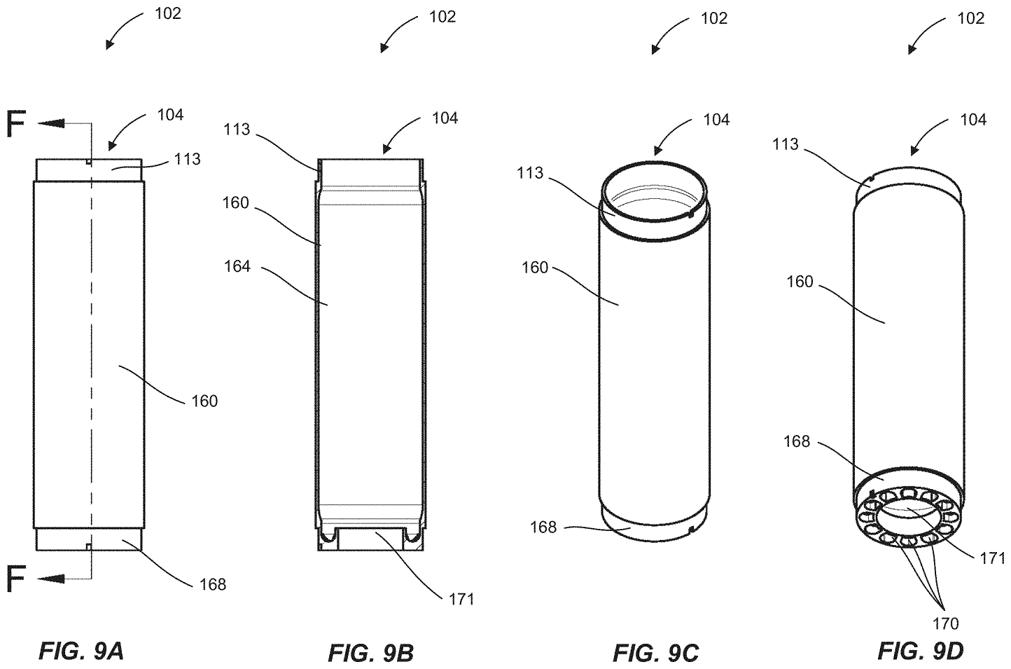

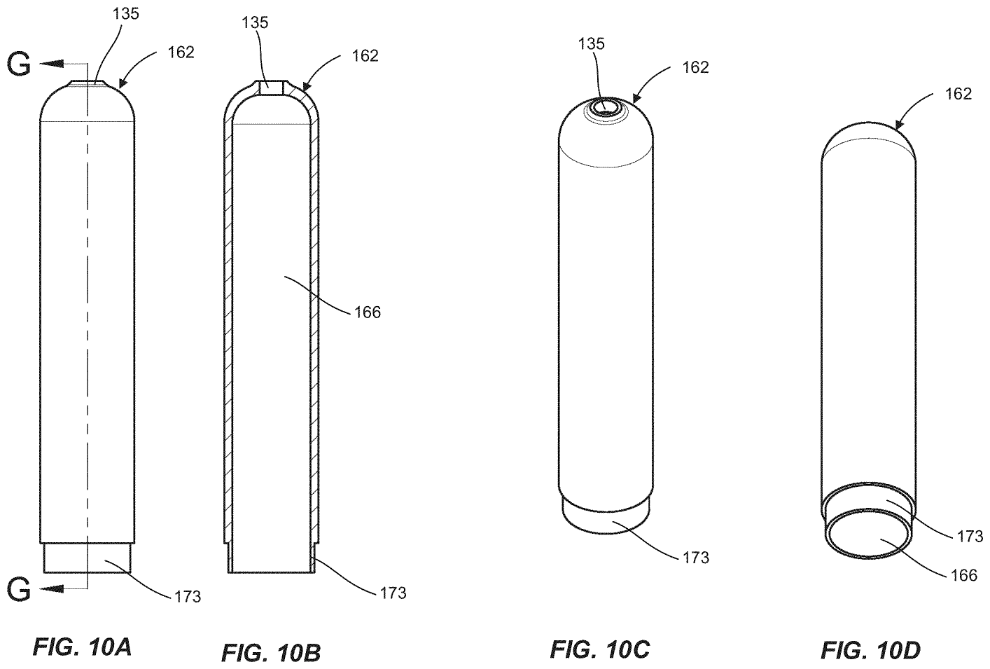

FIGS. 9A, 9B, 9C, and 9D respectively illustrate a front view, a cross-sectional view (taken along line FF in FIG. 9A), an upper isometric view, and a lower isometric view of the fluid reservoir 102 of the horticulture device 100. As illustrated, the fluid reservoir 102 can include an outer housing 160 and an inner housing 127. The outer housing 160 can define an outer chamber 164 that is configured to surround the inner housing 127 (illustrated in FIGS. 10A-10D). The inner housing 127 can define an inner chamber 166 within the fluid reservoir 102. When the horticulture device 100 is assembled, the inner chamber 166 can house the drain 124. The fluid reservoir 102 can further include a base interface 168 configured to facilitate attachment of the fluid reservoir 102 to the base 106. At a bottom end of the outer chamber 164 of the fluid reservoir 102, one or more openings 170 can be formed in the outer housing 160 to provide fluid communication between the outer chamber 164 of the fluid reservoir 102 and the base 106. The fluid reservoir 102 can further include an inner chamber inlet 172 to allow fluid communication between the base 106 and the inner chamber 166. The fluid reservoir 102 can further include a cap interface 113 configured to interface with the cap 122.

FIGS. 10A, 10B, 10C, and 10D respectively illustrate a front view, a cross-sectional view (taken along line GG in FIG. 10A), an upper isometric view, and a lower isometric view of the inner housing 162 of the horticulture device 100. As illustrated, the inner housing 162 can define the inner chamber 166 that is configured to surround the inner housing 127 (illustrated in FIGS. 10A-10D). The inner housing 127 can define an inner chamber 166 within the fluid reservoir 102. When the horticulture device 100 is assembled, the inner chamber 166 can house the drain 124. The inner housing 162 can further include a base interface 173 configured to facilitate attachment of the inner housing 162 to the base 106. Except for fluid flowing to and from the base 106, the inner chamber 166 can be sealed off from the outer chamber 164 of the fluid reservoir to prevent air flow from the outer chamber 164 to the inner chamber 166 when the reservoir is filled with fluid.

The inner housing 127 can further include a fluid passage 135 formed therein that can allow fluid to pass there through. The fluid passage 135 can act as a tube interface for interfacing with tube 129 and to provide fluid communication between the tube 129 and the inner housing 127. The tube 129 can be housed inside of the drain 124 and the fluid reservoir 102 to convey fluid to a top of the fluid reservoir 102 out of the inner housing 127 from the bottom reservoir 300 through a middle of the fluid reservoir 102.

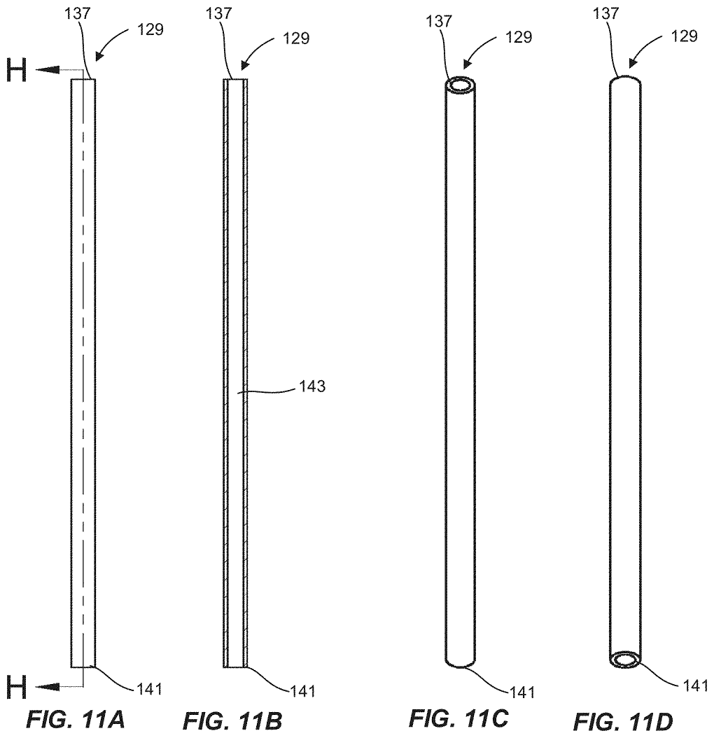

FIGS. 11A, 11B, 11C, and 11D respectively illustrate a front view, a cross-sectional view (taken along line HH in FIG. 11A), an upper isometric view, and a lower isometric view of the tube 129 of the horticulture device 100. As illustrated, tube 129 can include an upper opening 137 and a lower opening 141 to allow fluid to enter and exit the tube 129. Additionally, the tube 129 can define a passage 143 through which fluid is conveyed in the tube 129. The tube can interface with the tube interface/fluid passage 135 of the inner housing 127 at the upper end of the tube 129 and can interface with the pump P, or other tube at the lower end of the tube 129. The tube 129 can provide fluid communication between the bottom fluid reservoir 300 and the fluid reservoir 102.

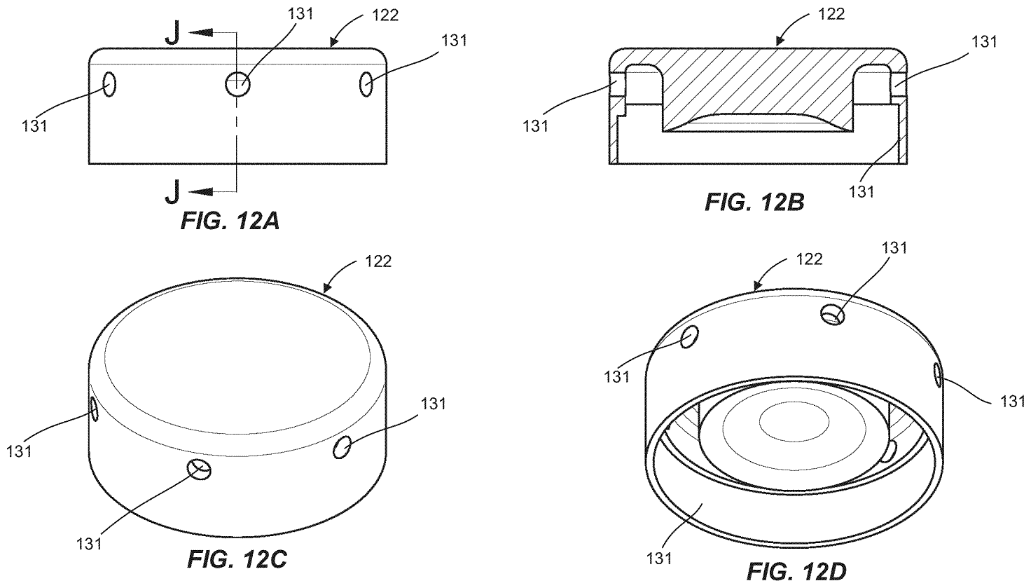

FIGS. 12A, 12B, 12C, and 12D respectively illustrate a front view, a cross-sectional view (taken along line JJ in FIG. 12A), an upper isometric view, and a lower isometric view of the cap 122 of the horticulture device 100. As illustrated, the cap 122 can include one or more inlets 131 formed therein to allow fluid to be introduced into the fluid reservoir 102 through the cap 122 or to act as air pressure releases or vents to allow for equalization of air pressure in the fluid reservoir 102 as the fluid reservoir 102 drains. The cap 122 can further include a reservoir interface 111 configured to interface and attach to the cap interface 113 of the fluid reservoir 102.

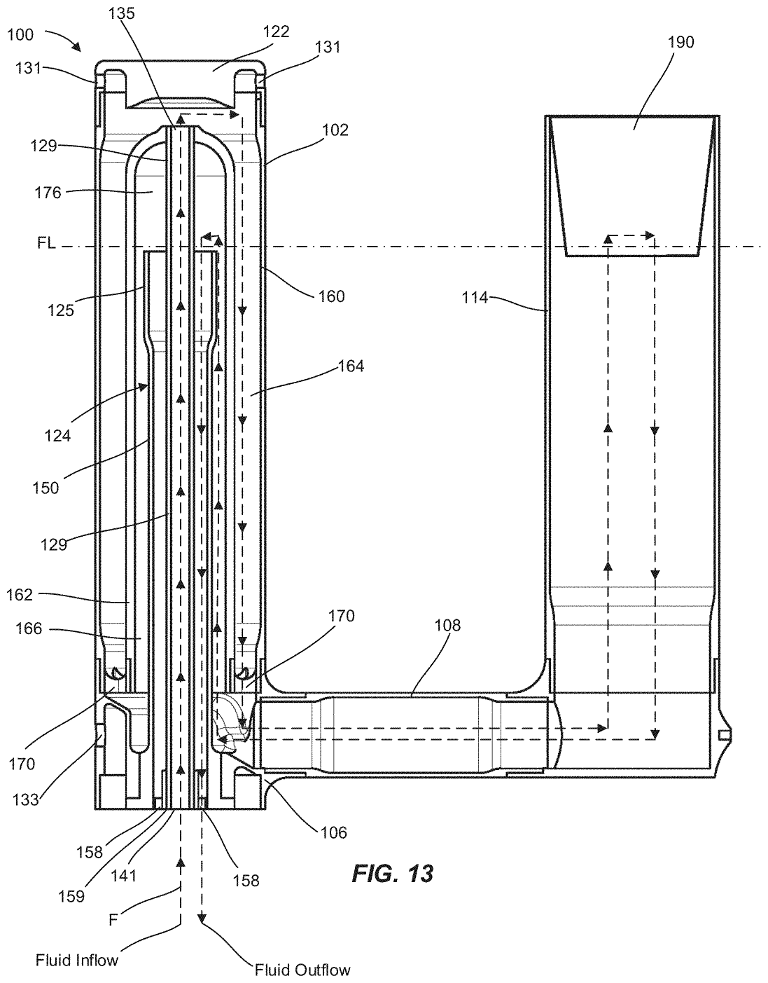

FIG. 13 illustrates cross-sectional view of an exemplary horticulture device 100 in accordance with at least one example disclosed herein. The horticulture device 100 shown in the figures is a bottom fill device where fluid is transported from a fluid reservoir at the bottom of the device and pumped to the top of the device through the tube 129. FIG. 13 illustrates a cross-sectional view of the horticulture device 100 taken along line AA shown in FIG. 4B with the bottom fluid reservoir 300 omitted. In FIG. 13, an example flow path of fluid is illustrated within the horticulture device 100. As illustrated, at the fluid inflow, a fluid F can enter the horticulture device 100 through the lower opening 141 of the tube 129. The fluid can be pumped into the lower opening 141 by a pump in a bottom fluid reservoir, such as bottom fluid reservoir 300. The fluid F can be pumped through the tube 129 to the top of the fluid reservoir 102 and can exit through the fluid passage 135 formed in the inner housing 162. The fluid F then flows in the outer chamber 164 defined by the outer housing 160 of the fluid reservoir 102 downward toward the base 106 and enters the base 106 through the holes 170 formed in the outer housing 160. From the base 106, the fluid flows into the arm 108 and up into the vegetation receptacle 114 to provide fluid F to a plant 190 in the receptacle 114. As fluid F fills the vegetation receptacle 114, the fluid F also enters the inner chamber 166 via the inner chamber inlet 172. As the fluid F rises in the vegetation receptacle 114, the fluid also rises upward in the fluid reservoir 102, specifically the inner chamber 166 and the outer chamber 164 of the fluid reservoir 102. When the fluid F rises to a level of the maximum fluid level FL in the horticulture device 100, the fluid F enters the funnel 125 of the drain 124. The fluid F then continues down the cavity 152 of the drain 124 and exits out of the holes 158 formed in the bottom of the drain 124 to exit the horticulture device 100 out of the outlet 120.

As illustrated in FIG. 13, the maximum fluid level in the horticulture device 100 is defined by the height of the drain 124 within the fluid reservoir 102. Once the fluid level reaches the height of the drain, the fluid F will not raise any higher in the fluid reservoir 102 and the fluid F will exit the horticulture device 100 through the drain 124. In other words, the opening 154 corresponds to the maximum fluid level for the fluid reservoir 102. Additionally, the inner chamber 166 containing the drain 124 can act as a siphon to siphon the fluid out of the horticulture device 100 when the fluid F flows down the drain 124. For example, with the inner chamber 166 filled with fluid F, the drain 124 is sealed off from an open air source. In other words, communication between the air outside the inlet 104 and the drain opening 154 is sealed off by positioning the drain 124 in the inner chamber 166 and a drain chamber 176. The positioning of the drain 124 provides a siphoning effect for the fluid F in the horticulture device 100. Therefore, when the fluid F flows down the drain 124, the force of the fluid F falling due to gravity creates low pressure above the drain 124 in the drain chamber 176. To compensate for the low pressure area in the drain chamber 176, the fluid F that is in the arm 108, the vegetation receptacle 114, the outer chamber 164, and inner chamber 166 of the fluid reservoir 102 is drawn upwards towards the drain chamber 176 without the aid of a pump P such that the fluid in the horticulture device 100 can be siphoned out of the horticulture device 100 without external driving forces. Accordingly, the drain chamber 176 that is in fluid communication with the fluid reservoir 102, the arms (e.g., 108), the vegetation receptacles (e.g., 114), and the base 106, is operable to siphon fluid from the fluid reservoir 102 through the drain 124.

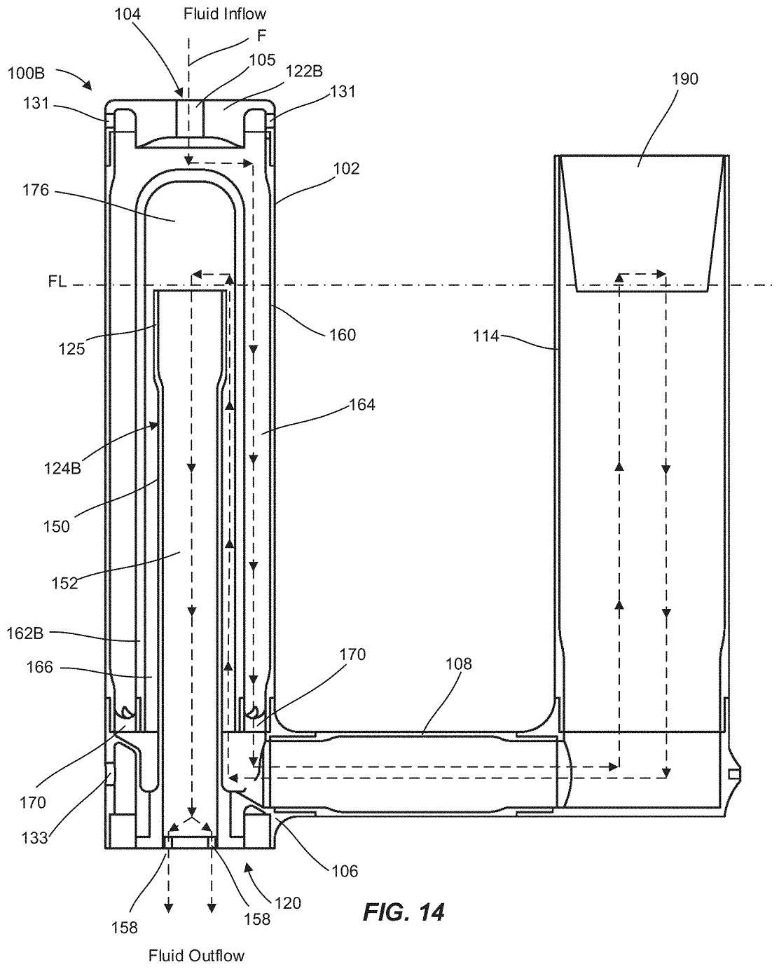

FIG. 14 illustrates an alternative configuration of the horticulture device 100. FIG. 14 illustrates cross-sectional view of an exemplary horticulture device 100B in accordance with at least one example disclosed herein. Horticulture device 100B includes many of the same components as illustrated in horticulture device 100. However, some differences are included in order to facilitate top filling of the horticulture device 100B in contrast to the bottom filling shown in horticulture device 100. For example, the cap 122 can be replaced by a cap 122B that can include a fluid inlet 105 formed therein configured to receive fluid in the top thereof to fill the fluid reservoir 102. Furthermore, the inner housing 162 can be replaced with an inner housing 162B that does not include the fluid passage 135 formed therein. The tube 129 can also be omitted when fluid is not being pumped up to the top of the fluid reservoir from a bottom fluid reservoir. With the tube 129 omitted, the drain 124 can be replaced by a drain 124B without the opening 159 formed therein to receive the tube 129.

FIG. 14 illustrates a cross-sectional view of the horticulture device 100B taken along line AA shown in FIG. 4B. In FIG. 14, an example flow path of fluid is illustrated within the horticulture device 100B. As illustrated, a fluid F can enter the horticulture device 100B through the inlet 104 in the cap 122B. The fluid F then flows in the outer chamber 164 defined by the outer housing 160 of the fluid reservoir 102 downward toward the base 106 and enters the base 106 through the holes 170 formed in the outer housing 160. From the base 106, the fluid flows into the arm 108 and up into the vegetation receptacle 114 to provide the fluid F to a plant 190 in the receptacle 114. As the fluid F fills the vegetation receptacle 114, the fluid F also enters the inner chamber 166 via the inner chamber inlet 172. As the fluid F rises in the vegetation receptacle 114, the fluid also rises upward in the fluid reservoir 102, specifically the inner chamber 166 and the outer chamber 164 of the fluid reservoir 102. When the fluid F rises to a level of the maximum fluid level FL in the horticulture device 100, the fluid enters the funnel 125 of the drain 124B. The fluid F then continues down the cavity 152 of the drain and exits out of the holes 158 formed in the bottom of the drain 124 to exit the horticulture device 100 out of the outlet 120.

As illustrated in FIG. 14, the maximum fluid level in the horticulture device 1006 is defined by the height of the drain 124B within the fluid reservoir 102. Once the fluid level reaches the height of the drain 124B, the fluid F will not raise any higher in the fluid reservoir 102 and the fluid F will exit the horticulture device 100B through the drain 124B. In other words, the opening 154 of the drain 124B corresponds to the maximum fluid level for the fluid reservoir 102. Additionally, the inner chamber 166 containing the drain 124B can act as a siphon to siphon the fluid out of the horticulture device 1006 when the fluid F flows down the drain 124B. For example, with the inner chamber 166 filled with fluid F the drain 124B is sealed off from an open air source. In other words, communication between the air outside the inlet 104 and the drain opening 154 is cut off by positioning the drain 124B in the inner chamber 166 and a drain chamber 176. Positioning of the drain 124B in this manner provides a siphoning effect for the fluid F in the horticulture device 1006. Therefore, when fluid F flows down the drain 124B, the force of the fluid F falling due to gravity creates low pressure above the drain 124B in the drain chamber 176. To compensate for the low pressure area in the drain chamber 176, fluid F that is in the arm 108, the vegetation receptacle 114, the outer chamber 164, and the inner chamber 166 of the fluid reservoir 102 is drawn upwards towards the drain chamber 176 without the aid of a pump P such that the fluid in the horticulture device 100B can be siphoned out of the horticulture device 1006 without external driving forces. Accordingly, the drain chamber 176 that is in fluid communication with the fluid reservoir 102, the arms (e.g., 108), the vegetation receptacles (e.g., 114), and the base 106, is operable to siphon fluid from the fluid reservoir 102 through the drain 124B.

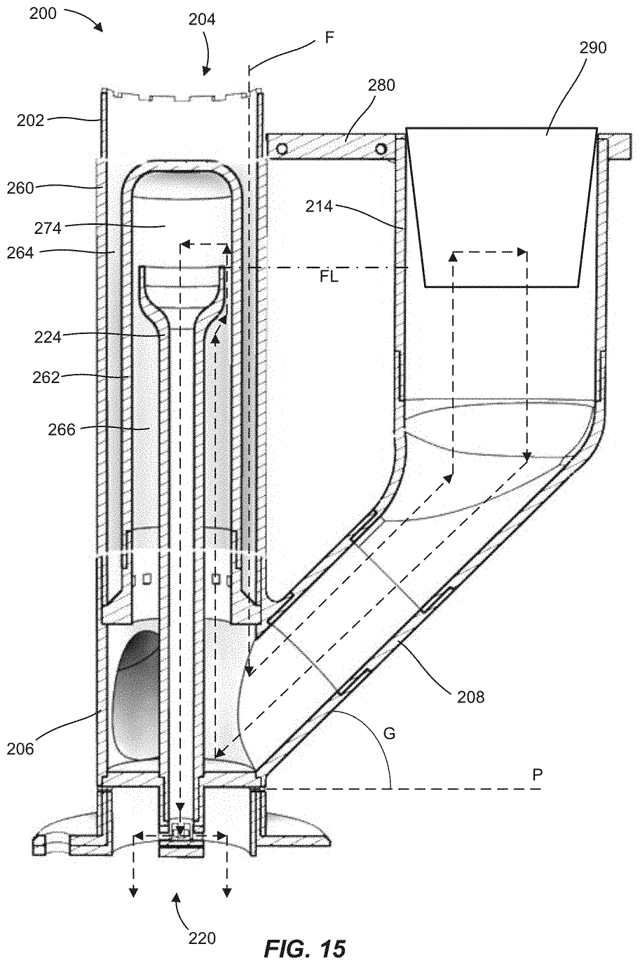

FIG. 15 illustrates an alternative horticulture device 200 according to at least one example of the present disclosure. As shown in FIG. 15, horticulture device 200 can include a fluid reservoir 202 having a fluid inlet 204 formed therein. The fluid reservoir 202 can include an outer housing 260 defining an outer chamber 264 and an inner housing 262 defining an inner chamber 266 that houses a drain 224. The fluid reservoir 202 can be in fluid communication with a base 206, an arm 208 extending away from and in fluid communication with the base 206, and a vegetation receptacle 214 in fluid communication with the arm 208, the base 206, and the fluid reservoir 202. As shown in the figure, the arm can be angled with respect to a horizontal plane P of the base 206. The angle between the plane P and the arm 208 is not particularly limited by this disclosure. The arm 208 can be angled at an angle of 0 degrees with respect to plane P to 60 degrees with respect to plane P and even greater if desired. The angle of the arm 208 with respect to the plane P can facilitate the draining of fluid from the vegetation receptacle 214 due to gravity aiding in the flow of fluid that is siphoned away by drain 224. Additionally, angling the arm can allow more room for a plant 290 to grow using the horticulture device 200.

The plant 290 illustrated in FIG. 15 represents the water receiving portion of the plant 290. The method of supporting the plant 290 within the vegetation receptacle 214 is not intended to be limited in any way by this disclosure. In designing, building, and/or using the horticulture device 200, the angle G of the arm 208 relative the plane P can be set or adjusted to either raise or lower the vegetation receptacle 214 and plant 290 relative to the fluid level FL corresponding to the height of the drain 224 in order to set a soaking depth and soaking time for the plant 290 in the vegetation receptacle 214. For example, if the angle of the arm is lower then what is shown in the figure, then more of the plant 290 will be submerged in fluid, thereby increasing the plants 290 exposure to fluid. Conversely, the angle of the arm can be increased to raise the plant 290 relative to the fluid level FL, thereby decreasing the amount of exposure for the plant 290 to the fluid. The same adjusting of plant exposure to fluid can also be accomplished by lengthening or shortening the arm 208 or by raising or lowering the opening of the drain 224. Accordingly, the exposure time and depth a plant has to fluid is adjustable in the horticulture devices described herein.

The fluid flow F within the horticulture device 200 is illustrated in FIG. 15. The fluid F can flow from the inlet 204 to the outlet 220 along the path shown. The horticulture device 200 can further include a support 280 connected to the fluid reservoir 202 and the vegetation receptacle 214 to provide support, stabilization, and bracing for the vegetation receptacle 214.

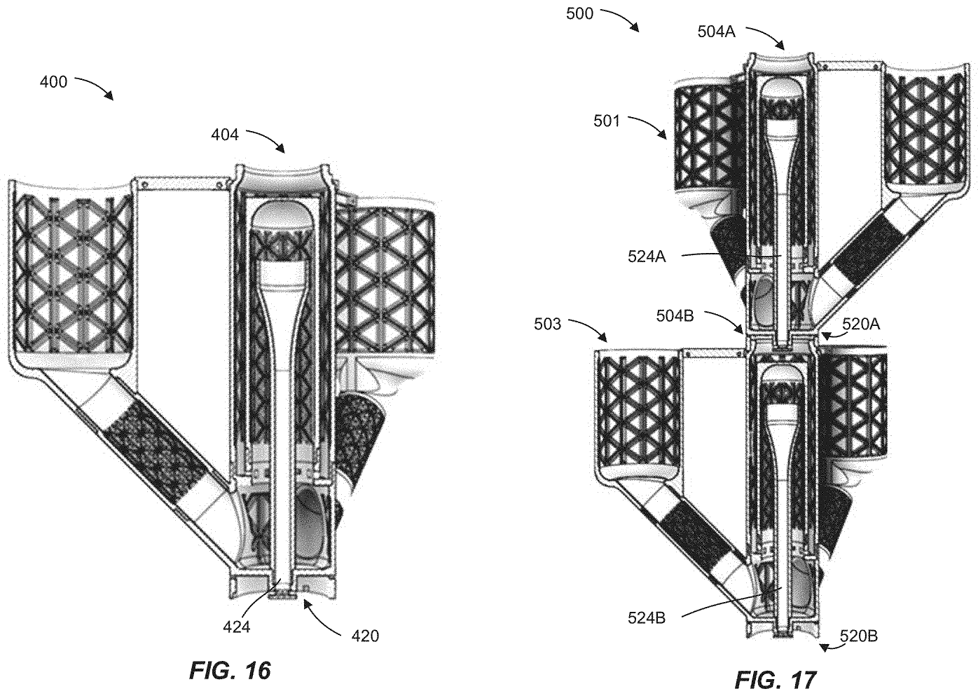

FIG. 16 illustrates cross-sectional view of a horticulture device 400 in accordance with at least one example of the present disclosure. The horticulture device 400, as well as all horticulture devices described herein, can be used individually as a single plant growing apparatus. As shown in FIG. 16, fluid can be provided in the inlet 404 of horticulture device 400 and can exit the horticulture device 400 out of drain 424 through fluid outlet 420. The fluid can empty into the external environment, a pond, a lagoon, a lake, or other body of water. Additionally, a pump P may be utilized to pump fluid from the body of water into the inlet 404 of the horticulture device to supply fluid to plants growing therein.

FIG. 17 illustrates cross-sectional view of a horticulture system 500 in accordance with at least one example of the present disclosure. The horticulture system 500 shows that a plurality of horticulture devices including a first horticulture device 501 and a second horticulture device 503 can be used stacked on top of each other. In this configuration, fluid can be provided to the fluid inlet 504A of the first horticulture device 501 and can exit through the drain 524A through outlet 520A. As the fluid exits the first horticulture device 501, the fluid enters the fluid inlet 504B of the second horticulture device 503 which is in fluid communication with the fluid inlet 504A of the first horticulture device. After flowing through the second horticulture device 503, the fluid can exit drain 524B through fluid outlet 520B. The stacked configuration of the horticulture devices in the horticulture system 500 can lead to a cascading siphon effect. For example, fluid exiting the first horticulture device 501 through the drain 524A causes the fluid in the first horticulture device 501 to be siphoned out. The fluid then enters the second horticulture device 503. If more fluid is added to the first horticulture device, the fluid that is siphoned out will enter the already filled second horticulture device 503 and cause a siphoning effect to siphon fluid out of the second horticulture device 503. Any number of horticulture devices can be stacked.

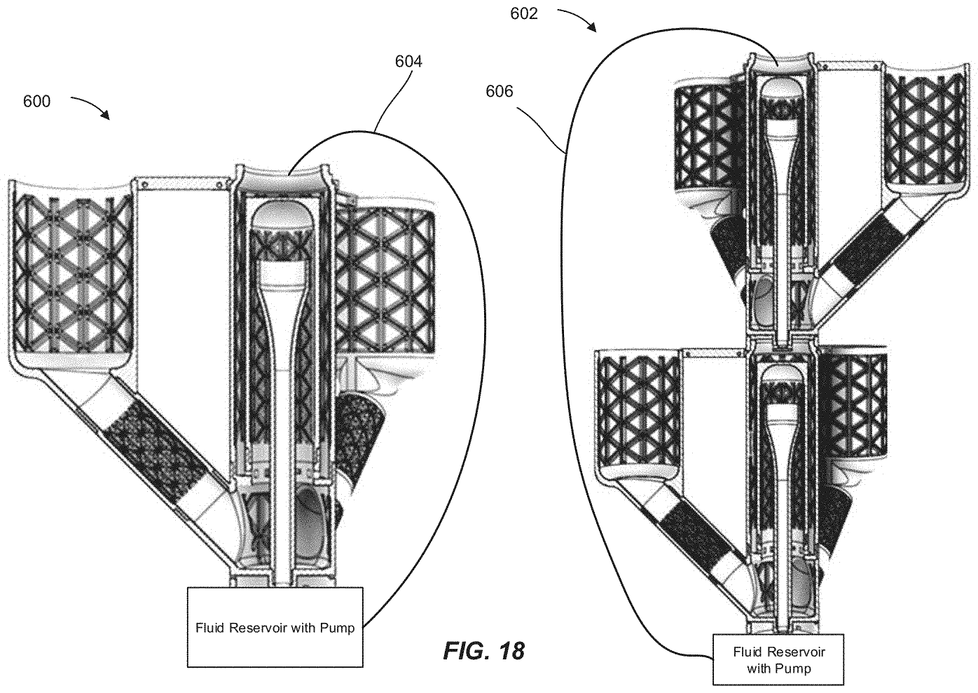

FIG. 18 illustrates both a single horticulture device system 600 and a multiple horticulture device system 602. As illustrated, each of the systems 600 and 602 can be connected to a fluid reservoir (e.g., pond, lake, lagoon, container, or other body of fluid) with a pump P. In both cases, the pump P can be utilized to pump water from the fluid reservoir to fluid inlets of the systems 600 and 602 through hoses 604 and 606. In this manner fluid that has already cycled through the horticulture systems can be recycled and provided multiple times to the plants contained in the systems 600 and 602, thereby reducing the amount of fluid needed to run the horticulture systems.

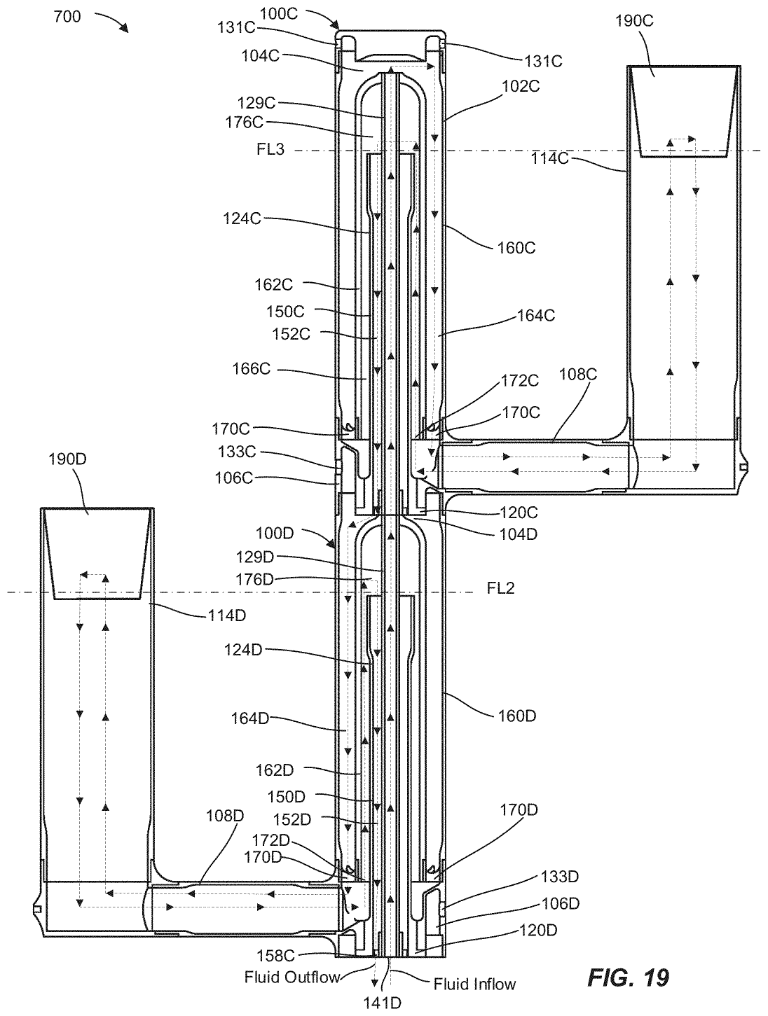

FIG. 19 illustrates a cross-sectional view of a horticulture system 700 including a stacked configuration of two horticulture devices similar to horticulture device 100 stacked on top of each other. In FIG. 19, a first horticulture device 100C is stacked on top of a second horticulture device 100D. As shown, horticulture device 100C and horticulture device 100D are stacked, connected, and interfaced together such that fluid exiting a bottom 120C of horticulture device 100C enters a top 104D of horticulture device 100D. An example flow path of fluid is illustrated within the horticulture system 700. As illustrated the horticulture system 700 is a bottom fill horticulture system where fluid is pumped from the bottom of the system into horticulture device 100C. It will be appreciated that similar stacked configurations are also possible in which the system is filled from the top of the upper most horticulture device such as shown in FIG. 14.

The flow of fluid F within the system 700 can proceed as follows. A fluid F can enter the horticulture device 100D through an inlet 141C of a tube 129D. The fluid can be pumped into the tube 129D by a pump from a fluid reservoir in fluid communication with the tube 129D. The fluid F can then proceed through the tube 129D to a tube 129C of the horticulture device 100C that is in fluid communication with the tube 129C. As shown, the tube 129C is housed within a housing 162C and drain 124C, and the tube 129D is housed within a housing 162D and drain 124D. The tubes 129D and 129C can convey the fluid F to an outer chamber 164C of the horticulture device 100C inside of a housing 160C of a fluid reservoir 102C of the horticulture device 100C.

The fluid F then flows in the outer chamber 164C defined by the outer housing 160C of the fluid reservoir 102C downward toward the base 106C and enters the base 106C through holes 170C formed in the outer housing 160C. From the base 106C, the fluid flows into the arm 108C and up into the vegetation receptacle 114C to provide fluid F to a plant 190C in the receptacle 114C. As fluid F fills the vegetation receptacle 114C, fluid F also enters the inner chamber 166C via the inner chamber inlet 172C. As the fluid F rises in the vegetation receptacle 114C, the fluid also rises upward in the fluid reservoir 102C, specifically the inner chamber 166C and outer chamber 164C of the fluid reservoir 102C. When the fluid F rises to a level of the maximum fluid level FL in the horticulture device 100C, the fluid enters the funnel 125C of the drain 124C. The fluid F then continues down the cavity 152C of the drain and exits out of holes 158C formed in the bottom of the drain 124C to exit the horticulture device 100C out of outlet 120C.

The maximum fluid level in the horticulture device 100C is defined by the height of the drain 124C within the fluid reservoir 102C. Once the fluid level reaches the height of the drain 124C, the fluid F will not raise any higher in the fluid reservoir 102C and the fluid F will exit the horticulture device 100C through the drain 124C. In other words, the opening 154C of the drain 124C corresponds to the maximum fluid level for the fluid reservoir 102C. Additionally, the inner chamber 166C containing the drain 124C can act as a siphon to siphon the fluid out of the horticulture device 100C when the fluid F flows down the drain 124C. For example, with the inner chamber 166C filled with fluid F, the drain 124C is sealed off from an open air source. In other words, communication between the air outside the inlet 104C and the drain opening 154C is cut off by positioning the drain 124C in the inner chamber 166C and a drain chamber 176C. This positioning of the drain 124C provides a siphoning effect for the fluid F in the horticulture device 100C. Therefore, when fluid F flows down the drain 124C, the force of the fluid F falling due to gravity creates low pressure above the drain 124C in a drain chamber 176C. To compensate for the low pressure area in the drain chamber 176C, fluid F that is in the arm 108C, the vegetation receptacle 114C, the outer chamber 164C, and inner chamber 166C of the fluid reservoir 102C is drawn upwards towards the drain chamber 176C without the aid of a pump P such that the fluid in the horticulture device 100C can be siphoned out of the horticulture device 100C without external driving forces. Accordingly, the drain chamber 176C that is in fluid communication with the fluid reservoir 102C, the arms (e.g., 108C), the vegetation receptacles (e.g., 114C), and the base 106C, is operable to siphon fluid from the fluid reservoir 102C through the drain 124C.

From the drain 124C of the fluid reservoir 102C, the fluid F flows into horticulture device 100D. Specifically, the fluid F flows into the outer chamber 164D of the fluid reservoir 102D of the horticulture device 100D in fluid communication with the horticulture device 100C. By the siphoning effect created by the fluid F exiting the horticulture device 100C, some, most, or all of the fluid F previously contained in the horticulture device 100C is siphoned into the horticulture device 100D. The siphoning effect can leave the horticulture device 100C at least partially, mostly, or completely drained of fluid F and the fluid can be reused to provide hydration to the horticulture device 100D.

The fluid F in the outer chamber 164D defined by the outer housing 160D of the fluid reservoir 102D can flow downward toward the base 106D and enter the base 106D through holes 170D formed in the outer housing 160D. From the base 106D, the fluid flows into the arm 108D and up into the vegetation receptacle 114D to provide fluid F to a plant 190D in the receptacle 114D. As fluid F fills the vegetation receptacle 114D, fluid F also enters the inner chamber 166D via the inner chamber inlet 172D. As the fluid F rises in the vegetation receptacle 114D, the fluid also rises upward in the fluid reservoir 102D, specifically the inner chamber 166D and outer chamber 164D of the fluid reservoir 102D. When the fluid F rises to a level of the maximum fluid level FL in the horticulture device 100D, the fluid enters the funnel 125D of the drain 124D. The fluid F then continues down the cavity 152D of the drain and exits out of holes 158D formed in the bottom of the drain 124D to exit the horticulture device 100D out of outlet 120D.

The maximum fluid level in the horticulture device 100D is defined by the height of the drain 124D within the fluid reservoir 102D. Once the fluid level reaches the height of the drain 124D, the fluid F will not raise any higher in the fluid reservoir 102D and the fluid F will exit the horticulture device 100D through the drain 124D. In other words, the opening 154D of the drain 124D corresponds to the maximum fluid level for the fluid reservoir 102D. Additionally, the inner chamber 166D containing the drain 124D can act as a siphon to siphon the fluid out of the horticulture device 100D when the fluid F flows down the drain 124D. For example, with the inner chamber 166D filled with fluid F, the drain 124D is sealed off from an open air source. In other words, communication between the air outside the inlet 104D and the drain opening 154D is cut off by positioning the drain 124D in the inner chamber 166D and a drain chamber 176D. This positioning of the drain 124D provides a siphoning effect for the fluid F in the horticulture device 100D. Therefore, when fluid F flows down the drain 124D, the force of the fluid F falling due to gravity creates low pressure above the drain 124D in a drain chamber 176D. To compensate for the low pressure area in the drain chamber 176D, fluid F that is in the arm 108D, the vegetation receptacle 114D, the outer chamber 164D, and inner chamber 166D of the fluid reservoir 102D is drawn upwards towards the drain chamber 176D without the aid of a pump P such that the fluid in the horticulture device 100D can be siphoned out of the horticulture device 100D without external driving forces. Accordingly, the drain chamber 176D that is in fluid communication with the fluid reservoir 102D, the arms (e.g., 108D), the vegetation receptacles (e.g., 114D), and the base 106D, is operable to siphon fluid from the fluid reservoir 102D through the drain 124D.

From the drain 124D of the fluid reservoir 102D, the fluid F flows into an outside environment or fluid reservoir for storage and/or recycling. By the siphoning effect created by the fluid F exiting the horticulture device 100D, some, most, or all of the fluid F previously contained in the horticulture device 100D is siphoned out of the horticulture device 100D. The siphoning effect can leave the horticulture device 100D at least partially, mostly, or completely drained of fluid F. Fluid exiting horticulture device 100D and system 700 can be stored in a fluid reservoir and can be pumped again to the top of the system 700 to be reused in the system for providing hydration to plants in the horticulture devices 100C and 100D.

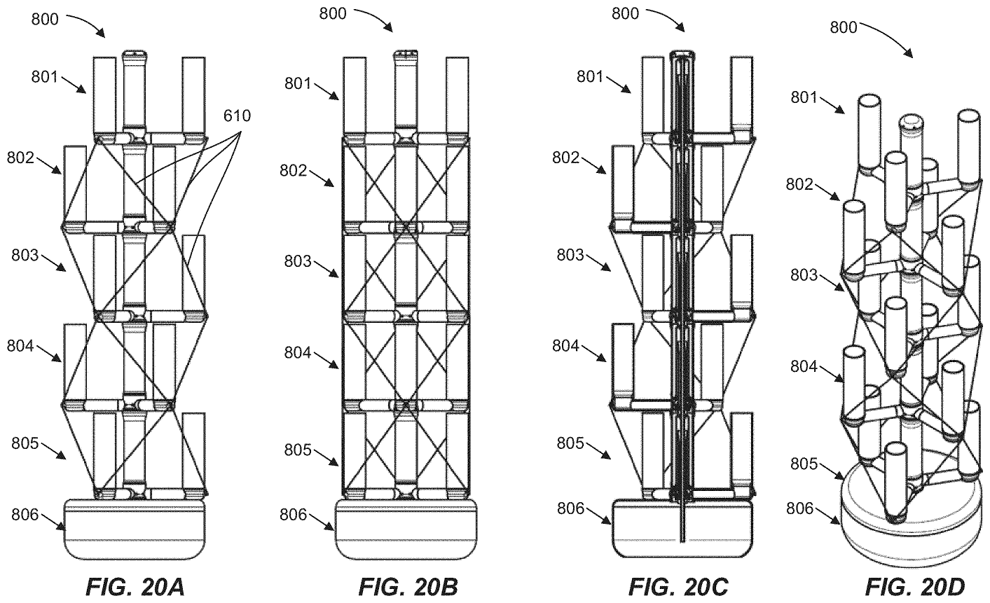

For example, as shown in FIGS. 20A, 20B, 20C, and 20D, a plurality of horticulture devices can be stacked in a horticulture system. As illustrated, horticulture system 800 can include horticulture devices 801, 802, 803, 804, and 805. The horticulture devices 801, 802, 803, 804, and 805 can each be of any configuration for a horticulture device described herein. Each fluid outlet/drain of a fluid reservoir of each horticulture device 801, 802, 803, 804, and 805 can be in fluid communication with a fluid inlet of a fluid reservoir of another horticulture device or a bottom fluid reservoir 806. In this configuration, with each horticulture device 801, 802, 803, 804, and 805 being in fluid communication with one or more other horticulture devices, a cascading siphoning effect can be achieved in the horticulture system 800. For example, water initially provided to horticulture device 801 will fill the horticulture device 801 to the maximum water level of the horticulture device 801. Adding additional fluid will cause at least some, most, or all of the fluid in the horticulture device 801 to siphon and drain into the horticulture device 802. The siphoning effect will aid the fluid in the horticulture device 801 in being drained into horticulture device 802. If more fluid is added to the horticulture device 801 until horticulture device 801 fills over the maximum fluid level, then fluid F will drain out of device 801. The fluid siphoned into the horticulture device 802 from horticulture device 801 will cause the fluid in horticulture device 802 to exceed the maximum water level horticulture device 802, at which point the fluid F in horticulture device 802 will be siphoned out of the horticulture device 802 and drain into the horticulture device 803. Adding more fluid to device 801 will cause fluid to exit device 801, which will cause fluid to enter device 802, which will cause fluid to exit device 802 and enter device 803, which will cause fluid to exit device 803, and so on and so on with horticulture devices 804, 805, and bottom fluid reservoir 806. Air inlets (e.g., inlets 133, 133C, or 133D) can be formed in each of horticulture devices 801, 802, 803, 804, and 805, such as shown in FIGS. 13, 14, and 19, to allow for siphons between levels to break as fluid fills each level of horticulture devices 801, 802, 803, 804, and 805.

The siphoning effect within the system 800 is such that the output of fluid siphoned away from a certain level of horticulture devices 801, 802, 803, 804, and 805 is greater than the input required to initiate the siphoning effect. In other words, once a horticulture device (e.g., horticulture devices 801, 802, 803, 804, and 805) is filled to a maximum fluid level, only a relatively small amount of fluid is required to initiate the siphoning effect to draw the fluid out of the horticulture device. For example, if the horticulture device is filled with an amount of fluid Y, some, most, or even all of the complete amount of fluid Y can be drained out of the horticulture device by adding only a fraction of the total amount of fluid Y.

Individual levels of the horticulture devices 801, 802, 803, 804, and/or 805 can be filled without pumping fluid to the top of horticulture device 801. For example, a specific level can be individually filled by adding fluid through inlets or by pouring fluid into vegetation receptacles of a certain level of horticulture devices 801, 802, 803, 804, and/or 805.

Ideally, all of the horticulture devices 801, 802, 803, 804, and 805 should not be filled with fluid at the same time in order to prevent overflowing of the system 800. However, as a failsafe, if the entire tower of horticulture system 800 is filled with fluid, then adding more fluid to the first horticulture device 100 can still cycle the fluid through all horticulture devices and can cause a cascading effect where all of the horticulture devices 801, 802, 803, 804, and 805 empty their previous fluid, which is replaced with fluid from the immediately preceding horticulture device.

According to the configurations described herein, the fluid can be easily cycled through each level of the horticulture system, and each batch of fluid can be used to water multiple levels of the horticulture system 800, thereby maximizing efficiency in watering and minimizing the amount of water needed to water multiple levels of a horticulture system. The water of the system can further be recycled by attaching a pump P to the bottom fluid reservoir to pump water that has gone through the system 800 back up to horticulture device 801 so that it can be used to water the horticulture system 800 again. Therefore, the horticulture system and devices described herein can function to maximize the usage of limited supplies of water by recycling and reusing a small supply of water or fluid to hydrate and/or nourish multiple growing plants.

As further shown in FIGS. 20A-20D, the horticulture system 800 can further include a plurality of supports 710 attached from one vegetation receptacle to another in order to provide structural rigidity to the horticulture system 800 and to provide support and bracing to each vegetation receptacle in order to better support the weight of the receptacle, the vegetation contained therein, and the fluid contained therein.

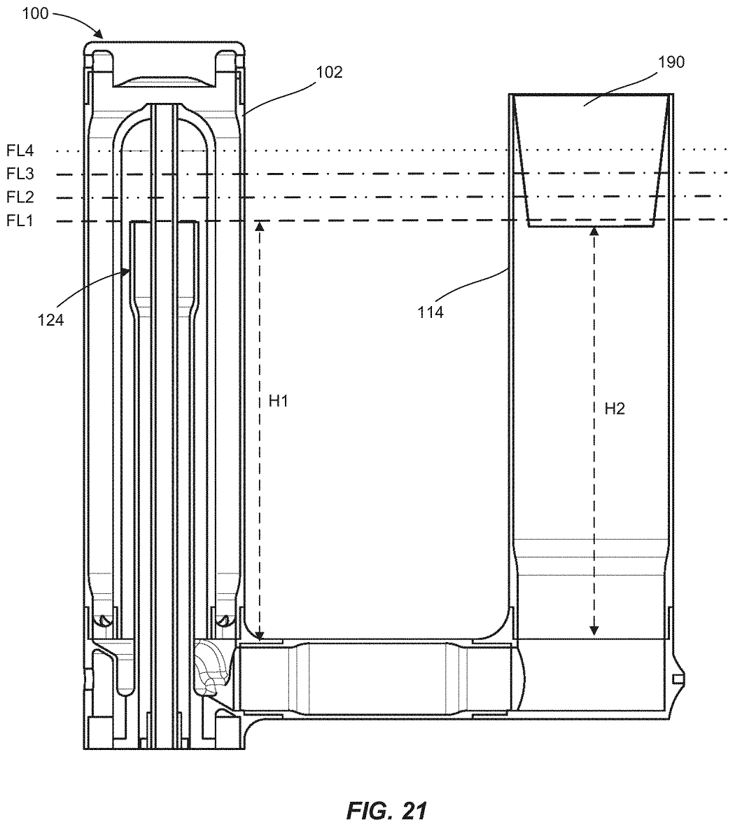

As described elsewhere, the maximum fluid level in a horticulture device 100 is defined by the height of the drain 124 within the fluid reservoir 102. Once the fluid level reaches the height of the drain 124, the fluid F will not raise any higher in the fluid reservoir 102 and the fluid F will exit the horticulture device 100 through the drain 124. In other words, the opening of the drain 124 corresponds to the maximum fluid level for the fluid reservoir 102. FIG. 21 illustrates the relationship between the height H1 of the drain 124 and the height H2 of the bottom of the plant 190 disposed in the vegetation receptacle 114. The height H2 of the bottom of the plant 190 within the vegetation receptacle 114 can be a set height at which the plant 190 is supported at within the vegetation receptacle 114. The height H1 of the drain 124 relative to a bottom of the plant 190 can be set at different values in order to increase or decrease an amount of saturation and/or a submersion level in fluid for the plant 190. For example, as shown in FIG. 21 the drain 124 is set at a height H1 to correspond to a maximum fluid level of FL1. Accordingly, the fluid level within the horticulture device 100 reaches level FL1 before draining. Likewise, the plant 190 is submerged to a level of FL1. If the desired submersion level for the plant 190 corresponds to the fluid level FL1, then the drain 124 is at a correct height for providing water to the plant 190.

To increase submersion of the plant 190, a drain can be used that is higher than drain 124. For example, the drain can have an opening disposed at a height of level FL2. In other words, if the desired submersion level for the plant 190 is at FL2, then the opening of the drain should be set at the level FL2 in order to provide proper fluid levels top the plant 190 This will result in the maximum fluid level increasing to the fluid level indicated as FL2 and will increase the submersion and exposure of the plant 190 to fluid. Similarly, drains can be set at any other heights such as levels FL3 and FL4 to further increase the plants 190 submersion and exposure to fluid. The levels of the drain for setting the fluid level within the horticulture device are not intended to be limited in anyway. Thus, depending on the needs of the plant, the drain may be set to different heights to increase or decrease the plant's exposure to water. Additionally, the plant 190 may be set deeper or shallower within the vegetation receptacle 114 to adjust exposure to the fluid. Similarly, the height of the vegetation receptacle 114 can be changed such that the plant sits deeper or shallower in the fluid.

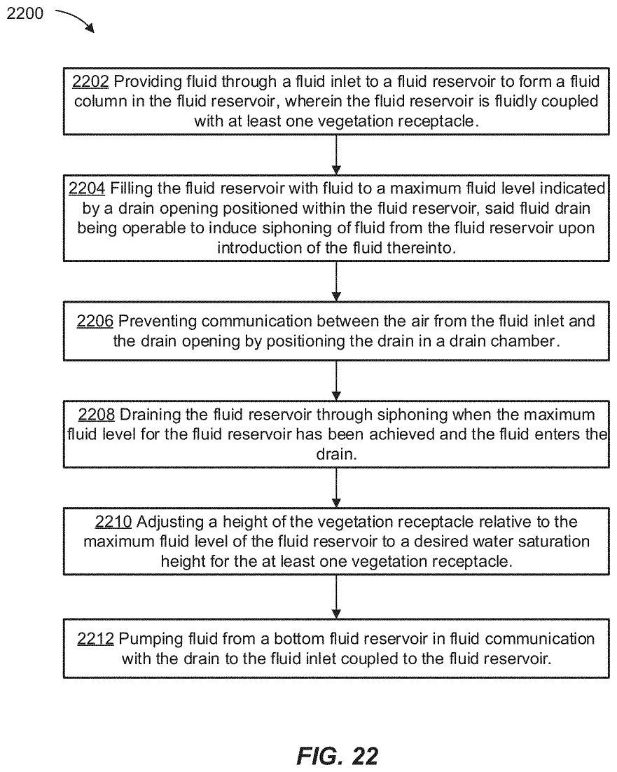

FIG. 22 illustrates a horticulture growing method 2200 according to at least one example of the present disclosure. The horticulture method 2200 can be used with any of the horticulture devices or systems described herein. The method 2200 can include a step 2202 of providing fluid through a fluid inlet to a fluid reservoir to form a fluid column in the fluid reservoir, wherein the fluid reservoir is fluidly coupled with at least one vegetation receptacle. The method 2200 can further include a step 2204 of filling the fluid reservoir with fluid to a maximum fluid level indicated by a drain opening positioned within the fluid reservoir, said fluid drain being operable to induce siphoning of fluid from the fluid reservoir upon introduction of the fluid thereinto. The method 2200 can further include a step 2206 of preventing communication between the air from the fluid inlet and the drain opening by positioning the drain in a drain chamber. The method 2200 can further include a step 2208 of draining the fluid reservoir through siphoning when the maximum fluid level for the fluid reservoir has been achieved and the fluid enters the drain. The method 2200 can further include a step 2210 of adjusting a height of the vegetation receptacle relative to the maximum fluid level of the fluid reservoir to a desired water saturation height for the at least one vegetation receptacle. The method 2200 can further include a step 2212 of pumping fluid from a bottom fluid reservoir in fluid communication with the drain to the fluid inlet coupled to the fluid reservoir.

Step 2208 can include draining the fluid reservoir through siphoning into another fluid reservoir, or out of the horticulture device, or into another horticulture device, or any other element, device, system, or environment.

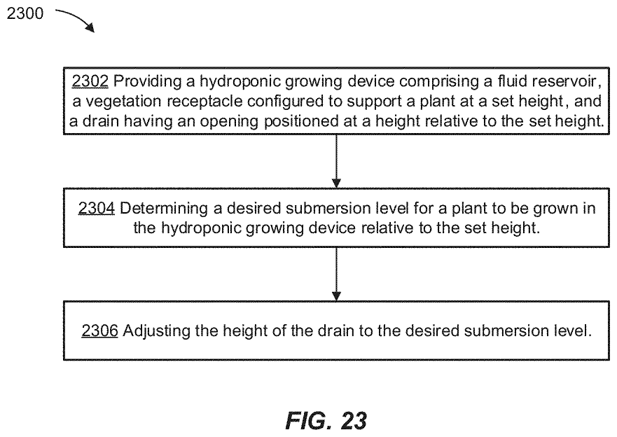

FIG. 23 illustrates a horticulture growing method 2300 according to at least one example of the present disclosure. The horticulture growing method 2300 can be used with any of the horticulture devices or systems described herein. The horticulture growing method 2300 can adjust the amount of water delivered to a plant based on a height relationship between a bottom of the plant and a height of a drain. The horticulture method 2300 can comprise a step 2302 of providing a horticulture growing device comprising a fluid reservoir, a vegetation receptacle configured to support a plant at a set height, and a drain having an opening positioned at a height relative to the set height. The method can further comprise a step 2304 of determining a desired submersion level for a plant to be grown in the horticulture growing device relative to the set height. The method can further comprise a step 2306 of setting a fluid height within horticulture device by adjusting the height of the drain to the desired submersion level. In a case in which the desired submersion level is above the fluid height within the horticulture device, the height of the drain can be raised to about substantially the same height as the desired submersion level for the plant. In a case in which the desired submersion level is below the fluid height within the horticulture device, the height of the drain can be lowered to about substantially the same height as the desired submersion level for the plant. The method can further comprise a step of placing a plant in the vegetation receptacle of the horticulture device. The method can further comprise a step of filling the horticulture device with fluid up to the desired submersion level. The method can further comprise a step of draining the horticulture device.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A horticulture device, comprising:
a fluid reservoir operable to receive fluid therein to form a fluid column inside the fluid reservoir;
a fluid inlet formed in the fluid reservoir to allow fluid to be introduced into the fluid reservoir;
at least one vegetation receptacle in fluid communication with said fluid reservoir; and
a drain positioned within the fluid reservoir having an opening corresponding to a maximum fluid level for the fluid reservoir.

2. The horticulture device of claim 1, wherein the fluid reservoir extends vertically from a base to form a housing for housing the fluid column, and the horticulture device further comprises:
at least one outer arm extending from the housing at an angle of greater than 0° and less than 60° relative to a horizontal plane of the base, wherein the at least one outer arm is in fluid communication with the at least one vegetation receptacle.

3. The horticulture device of claim 1, further comprising:
a drain chamber fluidly coupled to the fluid reservoir at the drain operable to siphon fluid from the fluid reservoir through the drain.

4. The horticulture device of claim 1, further comprising a funnel coupled to the drain.

5. The horticulture device of claim 2, wherein the at least one vegetation receptacle is fluidly coupled to the fluid reservoir via the at least one outer arm.

6. The horticulture device of claim 1, wherein a bottom portion of the at least one vegetation receptacle is fluidly coupled to the fluid reservoir, and a top portion of the at least one vegetation receptacle is not fluidly coupled to the fluid reservoir.

7. The horticulture device of claim 1, wherein a fluid weight distribution between the fluid reservoir that extends vertically from a base for housing the fluid column and at least one outer arm extending from the base increases stability of the horticulture device.

8. A method for moving fluid through a horticulture system, comprising:
providing fluid through a fluid inlet to a fluid reservoir to form a fluid column in the fluid reservoir that is fluidly coupled with at least one vegetation receptacle;
filling the fluid reservoir with fluid to a maximum fluid level indicated by a drain opening positioned within the fluid reservoir, said fluid drain being operable to induce siphoning of fluid from the fluid reservoir upon introduction of the fluid thereinto; and
draining the fluid reservoir through siphoning when the maximum fluid level for the fluid reservoir has been achieved and the fluid enters the drain.

9. The method of claim 8, further comprising:
preventing communication between the air from the fluid inlet and the drain opening by positioning the drain in a drain chamber.

10. The method of claim 8, further comprising:
adjusting a height of the vegetation receptacle relative to the maximum fluid level of the fluid reservoir to a desired water saturation height for the at least one vegetation receptacle.

11. The method of claim 8, further comprising:
pumping fluid from a bottom fluid reservoir in fluid communication with the drain to the fluid inlet coupled to the fluid reservoir.

12. A horticulture system, comprising:
a first horticulture device comprising:
a fluid reservoir operable to receive fluid therein to form a fluid column inside the fluid reservoir
a fluid inlet coupled to the fluid reservoir;
at least one vegetation receptacle in fluid communication with said fluid reservoir; and
a drain positioned within the fluid reservoir having an opening corresponding to a maximum fluid level for the fluid reservoir; and
a second horticulture device comprising:
a fluid reservoir operable to receive fluid therein to form a fluid column inside the fluid reservoir
a fluid inlet coupled to the fluid reservoir;
at least one vegetation receptacle in fluid communication with said fluid reservoir; and
a drain positioned within the fluid reservoir having an opening corresponding to a maximum fluid level for the fluid reservoir;
wherein the fluid reservoir of the first horticulture device is in fluid communication with the fluid reservoir of the second horticulture device.

13. The horticulture system of claim 12, wherein the drain of the first horticulture device is in fluid communication with the fluid inlet of the second horticulture device.

14. The horticulture system of claim 12,
wherein the fluid reservoir of the first horticulture device extends vertically from a base to form a housing for housing the fluid column; and
wherein the fluid reservoir of the second horticulture device extends vertically from a base to form a housing for housing the fluid column; and
wherein the first horticulture device further comprises:
at least one outer arm extending from the housing at an angle of greater than 0° and less than 60° relative to a horizontal plane of the base, wherein the at least one outer arm is in fluid communication with the at least one vegetation receptacle; and
wherein the second horticulture device further comprises:
at least one outer arm extending from the housing at an angle of greater than 0° and less than 60° relative to a horizontal plane of the base, wherein the at least one outer arm is in fluid communication with the at least one vegetation receptacle.

15. The horticulture system of claim 12,
wherein the first horticulture device further comprises:
a drain chamber surrounding the drain that is operable to siphon fluid from the fluid reservoir through the drain; and
an outer chamber surrounding the drain chamber and in fluid communication with the fluid inlet; and
wherein the second horticulture device further comprises:
a drain chamber surrounding the drain that is operable to siphon fluid from the fluid reservoir through the drain; and
an outer chamber surrounding the drain chamber and in fluid communication with the fluid inlet.

16. The horticulture system of claim 12, further comprising a bottom fluid reservoir in fluid communication with the drain of the second horticulture device and coupled to a pump operable to move fluid to the fluid inlet coupled to the fluid reservoir of the first horticulture device.

17. The horticulture system of claim 12, wherein the first horticulture device further comprises a funnel coupled to the drain; and
wherein the second horticulture device further comprises a funnel coupled to the drain.

18. The horticulture system of claim 12, wherein the at least one vegetation receptacle of the first horticulture device is fluidly coupled to the fluid reservoir of the first horticulture device via the at least one outer arm of the first horticulture device;
wherein the at least one vegetation receptacle of the second horticulture device is fluidly coupled to the fluid reservoir of the second horticulture device via the at least one outer arm of the second horticulture device.

19. The horticulture system of claim 12, further comprising:
one or more additional horticulture devices each comprising:
a fluid reservoir operable to receive fluid therein to form a fluid column inside the fluid reservoir
a fluid inlet coupled to the fluid reservoir;
at least one vegetation receptacle in fluid communication with said fluid reservoir; and
a drain positioned within the fluid reservoir having an opening corresponding to a maximum fluid level for the fluid reservoir;
wherein each of the fluid reservoirs of the one or more additional horticulture devices are in fluid communication with one or more of the fluid reservoirs of the first, second, and or additional horticulture devices.

20. The horticulture system of claim 19, wherein the horticulture system comprises a plurality of horticulture devices comprising the first horticulture device, the second horticulture device, the one or more additional horticulture devices;
wherein the plurality of horticulture devices are stacked in a vertical configuration with each of the fluid reservoirs of the plurality of horticulture devices being in fluid communication with one or more other fluid reservoirs of the plurality of horticulture devices;
wherein the horticulture system further comprises a bottom fluid reservoir in fluid communication with a drain of a bottommost horticulture device in the vertical configuration and the bottom fluid reservoir is coupled to a pump operable to move fluid to the fluid inlet coupled to the fluid reservoir of a topmost horticulture device in the vertical configuration.

21. A method for setting a fluid height in a horticulture device, comprising:
providing a hydroponic growing device comprising a fluid reservoir, a vegetation receptacle configured to support a plant at a set height, and a drain having an opening positioned at a height relative to the set height;
determining a desired submersion level for a plant to be grown in the hydroponic growing device relative to the set height; and
adjusting the height of the drain to the desired submersion level.
